(19) United States
(12) Patent Application Publication
(10) Pub. No.: US 2026/0322702 A1
(43) Pub. Date: Oct. 15, 2026

(54) TRAINING MACHINE LEARNING POSITIONING MODELS IN A WIRELESS COMMUNICATIONS NETWORK

(71) Applicant: Lenovo (Singapore) Pte. Limited, Singapore (SG)

(72) Inventors: Robin Rajan Thomas, Bad Nauheim (DE); Dimitrios Karampatsis, Ruislip (GB)

(73) Assignee: Lenovo (Singapore) Pte. Limited, Singapore (SG)

(21) Appl. No.: 19/101,188

(22) PCT Filed: Sep. 12, 2022
(86) PCT No.: PCT/EP2022/075258

§ 371 Date: Feb. 4, 2025

(30) Foreign Application Priority Data
Aug. 5, 2022 (GR) 20220100652

(51) Int. Cl. H04L 41/16; H04W 64/00

(52) U.S. Cl. CPC H04L 41/16; H04W 64/00

(57) ABSTRACT

There is provided a network node in a wireless communication network, comprising a transmitter arranged to send a positioning training dataset configuration to at least one data source of the wireless communication network, the positioning training dataset configuration comprising a request for a positioning training dataset for training a machine learning positioning model, and a required data format of the positioning training dataset based on a location of the network node. The network node further comprising a receiver arranged to receive a response from the at least one data source, the response comprising the positioning training dataset according to the required data format. The network node further comprising a processor arranged to train the machine learning positioning model using the positioning training dataset.

### FIELD

The subject matter disclosed herein relates generally to the field of implementing the training of machine learning positioning models in a wireless communications network. This document defines a network node in a wireless communications network, and a method in a network node, the network node in a wireless communications network.

### BACKGROUND

Positioning requirements for New Radio (NR) air interface (Uu) signals and standalone (SA) architecture (e.g. beam-based transmissions) for 3GPP has been specified in 3GPP Release 16. The target use cases also included commercial and regulatory (emergency services) scenarios as provided in 3GPP Release 15. Furthermore, current 3GPP Release 17 positioning has recently defined the positioning performance requirements for commercial and industrial internet of things (IIoT) use cases.

Positioning techniques in 3GPP can currently be configured and performed based on the requirements of the location management function (LMF) and UE capabilities. These techniques seek to enable the computation of a UE's location estimate.

### SUMMARY

Artificial intelligence (AI) and/or machine learning (ML) for air-interface corresponding to target use cases within a 3GPP framework is of relevance to CSI feedback, beam management and positioning accuracy enhancement, regarding aspects such as performance, complexity, and potential for specification impact. The use of AI/ML-based procedures to enhance different location procedures including 3GPP positioning procedures and/or signaling at RAN and/or UE and/or location server (LMF) is of particular interest and enhancements to the aforementioned aspects may be needed.

For example, AI/ML techniques can be implemented to optimize and predict different metrics in time and space (e.g. PRS/SRS configuration, final location accuracy) within a positioning session of a target-UE. There is therefore a need to support efficient model training and inference signaling mechanisms to enhance the measurement and reporting within the positioning framework with the assumption that the described training and inference models have already been deployed at the location server or NG-RAN/UE.

However, there is no known method in the current positioning framework to select, trigger and configure the collection of positioning data required for training a configured AI/ML positioning model. This includes both online and offline training of positioning data for a particular AI/ML model. In addition, the types of data sources are key in order for the input training dataset to be statistically significant, which influences the accuracy of the AI/ML model to be trained.

This disclosure presents apparatuses and methods which detail the support of different scenarios which can enable the selection, triggering and signaling of positioning training data to support the AI/ML framework for positioning. Disclosed herein are procedures for training machine learning positioning models in a wireless communication network. Said procedures may be implemented by network nodes and methods in network nodes.

There is provided a network node in a wireless communication network, comprising a transmitter arranged to send a positioning training dataset configuration to at least one data source of the wireless communication network, the positioning training dataset configuration comprising a request for a positioning training dataset for training a machine learning positioning model, and a required data format of the positioning training dataset based on a location of the network node. The network node further comprises a receiver arranged to receive a response from the at least one data source, the response comprising the positioning training dataset according to the required data format. The network node further comprises a processor arranged to train the machine learning positioning model using the positioning training dataset.

There is further provided a method in a network node, the network node in a wireless communication network, comprising sending a positioning training dataset configuration to at least one data source of the wireless communication network, the positioning training dataset configuration comprising a request for a positioning training dataset for training a machine learning positioning model, and a required data format of the positioning training dataset based on a location of the network node. The method further comprising receiving a response from the at least one data source, the response comprising the positioning training dataset according to the required data format. The method further comprising training the machine learning positioning model using the positioning training dataset.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for training machine learning positioning models in a wireless communication network will now be described, by way of example only, with reference to the accompanying drawings, in which:

FIG. 1 illustrates an embodiment of a wireless communication system;

FIG. 2 provides an illustration of an embodiment of a user equipment apparatus;

FIG. 3 provides an illustration of an embodiment of a network node;

FIG. 4 illustrates an embodiment of a system demonstrating NR beam-based positioning in a wireless communication network;

FIG. 5 illustrates an embodiment of a multi-cell RTT positioning procedure of a wireless communication network;

FIG. 6 illustrates an embodiment of relative range estimation using an existing single gNodeB RTT positioning framework;

FIG. 7 illustrates the RequestLocationInformation message body in a LPP message used by a location server to request positioning measurements;

FIG. 8 illustrates the ProvideLocationInformation message body in a LPP message used by a target device to provide positioning measurements;

FIG. 9 illustrates an embodiment of an AI/ML functional block diagram for RAN intelligence;

FIG. 10 illustrates an embodiment of a method in a network node, the network node in a wireless communication network;

FIG. 11 illustrates an embodiment of a system showing entities/nodes capable of performing AI/ML training using positioning input data in a wireless communication network;

FIG. 12 illustrates an embodiment of LMF based collection and training of positioning measurement data;

FIG. 13 illustrates an embodiment of methods and apparatus for NG-RAN based collection and training of positioning data;

FIG. 14 illustrates an embodiment of methods and apparatus for UE-based collection and training of positioning data;

FIG. 15 illustrates an embodiment of methods and apparatus for requesting and responding for positioning training data set collection;

FIG. 16 illustrates an embodiment of an AI/ML direct positioning training database structure; and

FIG. 17 illustrates an embodiment of an AI/ML assisted positioning training database structure.

### DETAILED DESCRIPTION

Direct artificial intelligence (AI)-based positioning and AI-assisted positioning methods can be leveraged in order to improve UE's location accuracy performance within a 3GPP defined positioning framework. Training of an AI/machine learning (ML) model using accurate and reliable positioning data is a critical component of this process in order to achieve the desired AI/ML positioning output. The disclosure herein details methods for supporting selection, triggering and signaling of positioning training data from configured data sources for both offline and online training of positioning data. By way of overview, the methods provide for selection and configuration of data sources depending on the network entity performing the AI/ML training; for the LMF to configure the collection of AI/ML training data for positioning purposes; for generating a training dataset depending on whether AI/ML direct (standalone) positioning or AI/ML assisted positioning is configured; or any combination thereof.

For the purposes of this disclosure, a positioning-related reference signal may be referred to as a reference signal used for positioning procedures/purposes in order to estimate a target-UE's location, e.g., PRS, or based on existing reference signals such as CSI-RS or SRS; a target-UE may be referred to as the device/entity to be localized/positioned. In various embodiments, the term ‘PRS’ may refer to any signal such as a reference signal, which may or may not be used primarily for positioning.

For the purposes of this disclosure, a target-UE may be referred to as a UE of interest whose position (absolute or relative) is to be obtained by the network or by the UE itself.

For the purposes of this disclosure, the terms AI and ML are used interchangeably to refer to an intelligent software component or system.

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

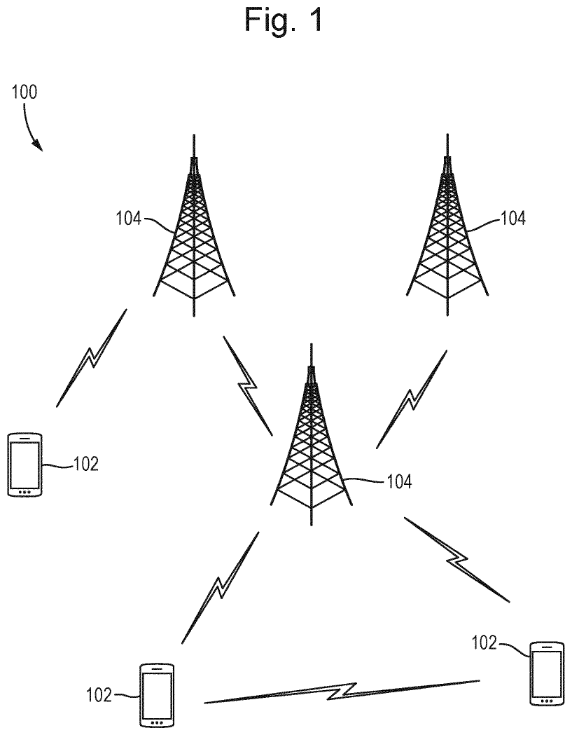

FIG. 1 depicts an embodiment of a wireless communication system 100 for training machine learning positioning models in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Location Management Function (“LMF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

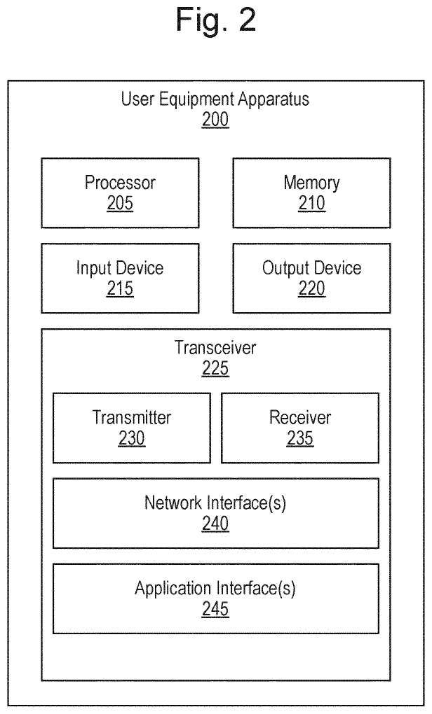

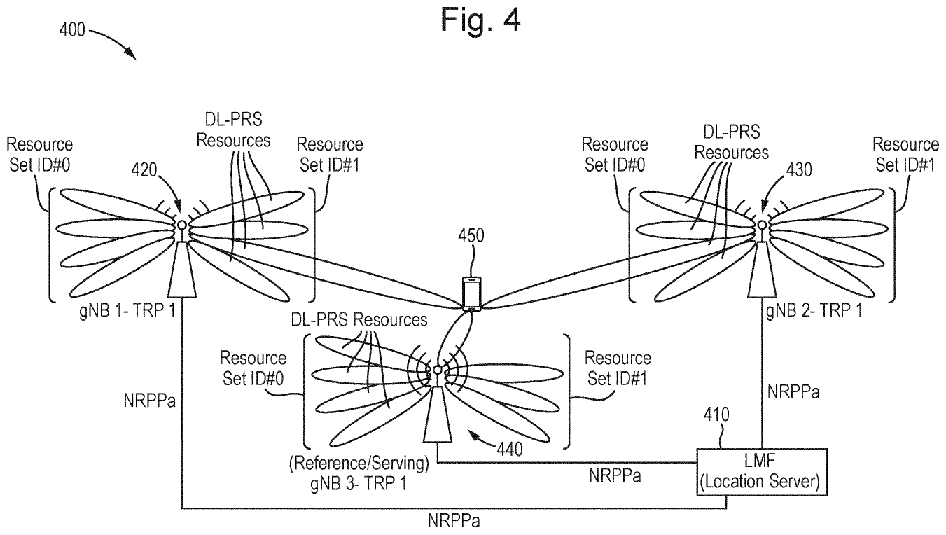

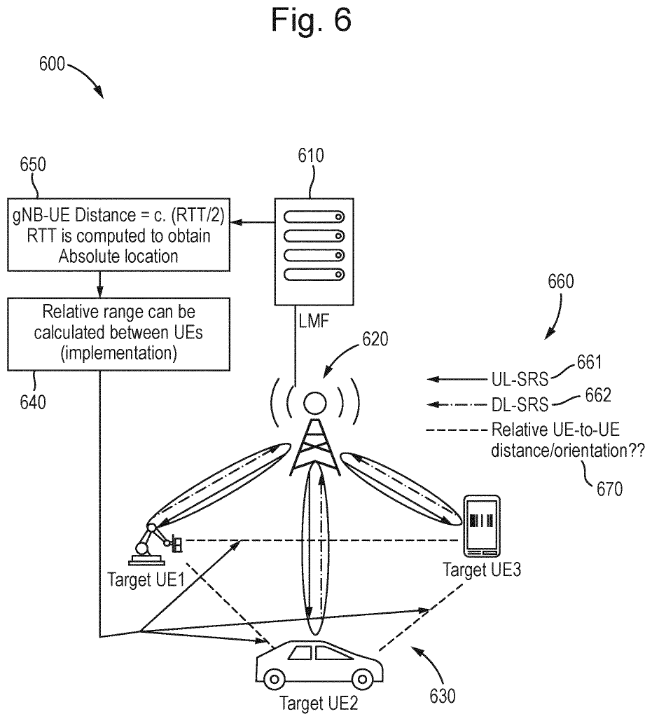

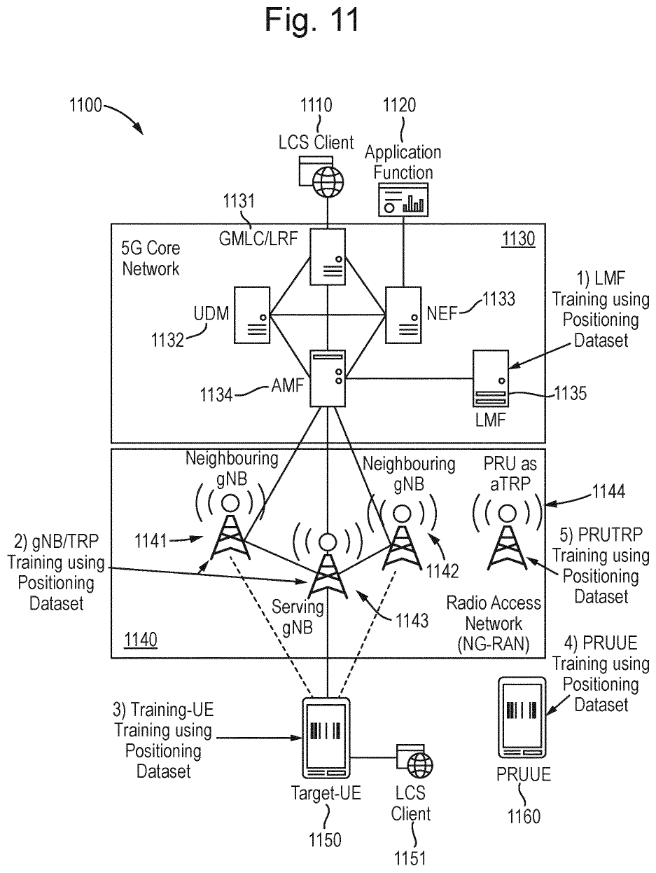

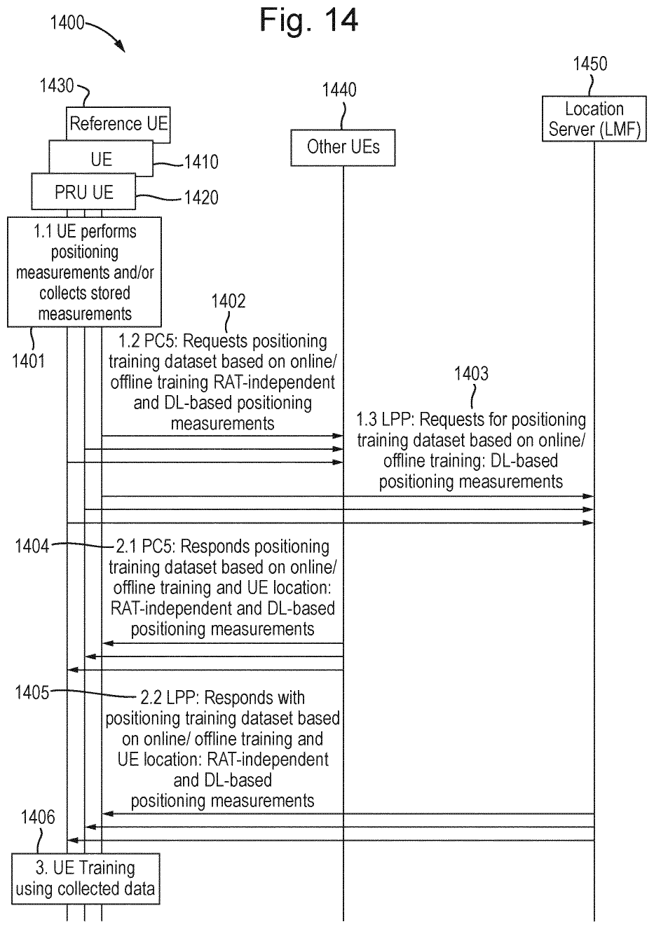

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may be the device 102 of FIG. 1, the device 540 of FIG. 4, the devices 630 of FIG. 6, the device 1150 or 1160 of FIG. 11, the devices 1410, 1420, 1430 of FIG. 14, and as such the reference numeral 200 is used hereinafter to indicate a user equipment apparatus in accordance with 102, 540, 630, 1150, 1160, 1410, 1420, 1430. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module.

Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

The memory 210 of user equipment apparatus 200 may host or store a machine learning positioning model for training using a positioning training dataset. The machine learning positioning model may be stored before and/or after training. The positioning training dataset may also be stored within memory 210 having been received through receiver 235 or from a local data source at the user equipment apparatus 200 or through measurement by the user equipment apparatus 200. The processor 205 is arranged to train the machine learning positioning model in some embodiments.

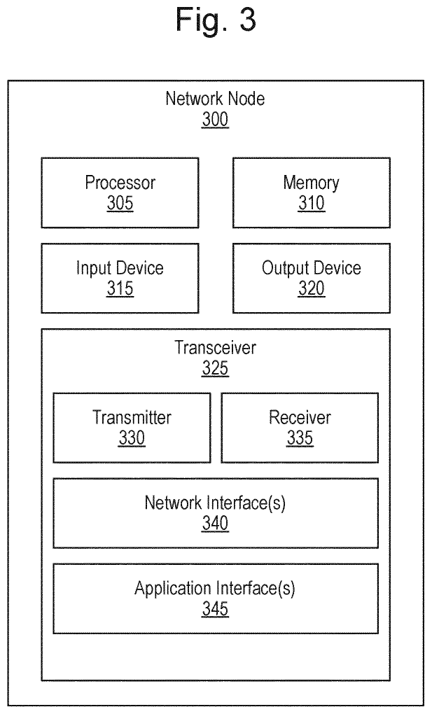

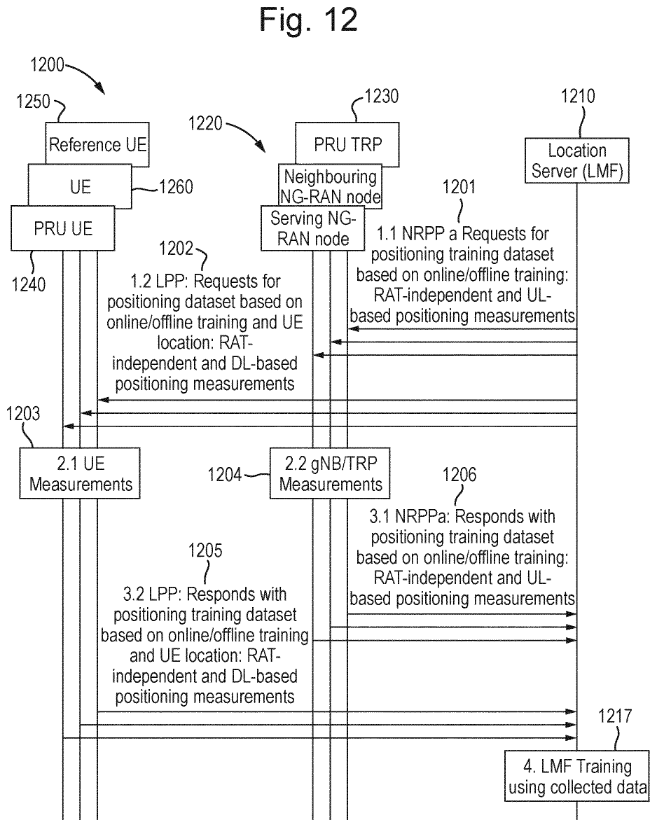

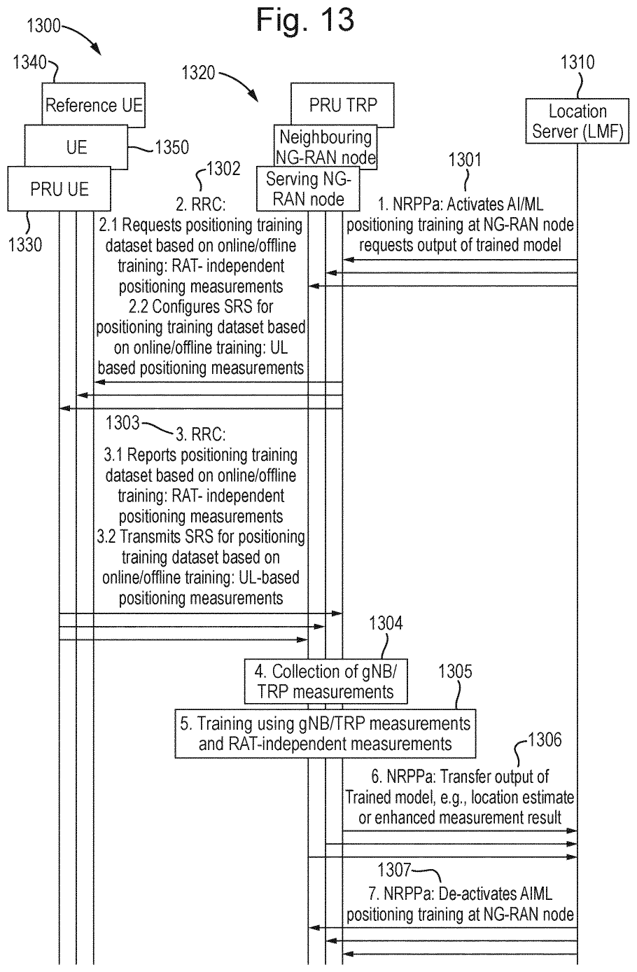

FIG. 3 depicts further details of the network node 300 that may be used for implementing the methods described herein. The network node 300 may be one implementation of an entity in the wireless communications network, e.g. in one or more of the wireless communications networks described herein, e.g. 104 in FIG. 1; 420, 430 or 440 of FIG. 4; 610 or 620 of FIG. 6; 1135, 1141, 1150, 1160, 1144 of FIG. 11; 1210 of FIG. 12; 1320 of FIG. 13; 1410, 1420, 1430 of FIG. 14. The network node 300 may be, for example, the UE 200 described above, or a Network Function (NF) or Application Function (AF), or another entity, of one or more of the wireless communications networks of embodiments described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 300. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

The memory 310 of network node 300 may host or store a machine learning positioning model for training using a positioning training dataset. The machine learning positioning model may be stored before and/or after training. The positioning training dataset may also be stored within memory 310 having been received through receiver 335 or from a local data source at the network node 300 or through measurement by the network node 300. The processor 305 is arranged to train the machine learning positioning model in some embodiments.

Positioning requirements for New Radio (NR) air interface (Uu) signals and standalone (SA) architecture (e.g. beam-based transmissions) for 3GPP has been specified in 3GPP Release 16. The target use cases also included commercial and regulatory (emergency services) scenarios as provided in 3GPP Release 15. The performance requirements from specification #38.855 are provided in Table 1 and comprise a horizontal positioning error of less than 3 m for 80% of UEs indoor; and less than 10 m for 80% of UEs outdoor. For vertical positioning the performance requirements comprise a vertical positioning error of less than 3 m for 80% of UEs; and less than 3 m for 80% of UEs outdoor.

TABLE 1

| Positioning Error | Indoor | Outdoor |
|---|---|---|
| Horizontal Positioning | <3 m for 80% of UEs | <10 m for 80% of UEs |
| Vertical Positioning | <3 m for 80% of UEs | <3 m for 80% of UEs |

Furthermore, current 3GPP Release 17 positioning has recently defined the positioning performance requirements for commercial and industrial internet of things (IIOT) use cases. These performance requirements from specification #38.857 are provided in Table 2 and comprise for commercial use cases positioning errors of less than 1 m for 90% of UEs for horizontal positioning; less than 3 m for 90% of UEs for vertical positioning; less than 10 ms for physical layer latency for position estimation of UE; and less than 100 ms end-to-end latency for position estimation of UE. For IIOT use cases the performance requirements comprise less than 0.2 m for 90% of UEs for horizontal positioning; less than 1 m for 90% of UEs for vertical positioning; less than 10 ms for physical layer latency for position estimation of UE; and less than 100 ms for end-to-end latency for position estimation of UE (although in the order of 10 ms is desired).

TABLE 2

| | | |
|---|---|---|
| Positioning Error | Commercial | IIoT |

| | | |
|---|---|---|
| Horizontal Positioning | (<1 m) for | (<0.2 m) for |
| | 90% of UEs | 90% of UEs |
| Vertical Positioning | (<3 m) for | (<1 m) for |
| | 90% of UEs | 90% of UEs |

| | | | |
|---|---|---|---|
| Physical layer latency for | (<10 | ms) | (<10 ms) |
| position estimation of UE | | | |
| End to End Latency for | (<100 | ms) | (<100 ms, in |
| position estimation of UE | | | the order of |
| | | | 10 ms is desired) |

Separate positioning techniques in 3GPP Release 16 from Specification #38.305 are indicated in Table 3. These positioning techniques can currently be configured and performed based on the requirements of the location management function (LMF) and UE capabilities.

TABLE 3

| | | | NG-RAN | |
|---|---|---|---|---|
| | UE- | UE-assisted, | node | Secure User Plane |
| Method | based | LMF-based | assisted | Location (SUPL) |
| A-GNSS | Yes | Yes | No | Yes (UE-based |
| | | | | and UE-assisted) |
| OTDOA | No | Yes | No | Yes (UE-assisted) |
| (Note 1, 2) | | | | |
| E-CID | No | Yes | Yes | Yes for E-UTRA |
| (Note 3) | | | | (UE-assisted) |
| Sensor | Yes | Yes | No | No |
| WLAN | Yes | Yes | No | Yes |
| Bluetooth | No | Yes | No | No |
| TBS | Yes | Yes | No | Yes (MBS) |
| (Note 4) | | | | |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

NOTE 1:
This includes TBS positioning based on PRS signals.
NOTE 2:
In this version of the specification only OTDOA based on LTE signals is supported.
.
NOTE 3:
This includes Cell-ID for NR method.
NOTE 4:
In this version of the specification only for TBS positioning based on MBS signals.

The transmission of positioning reference signals (PRS) enable the UE to perform UE positioning-related measurements to enable the computation of UE's location estimate and are configured per transmission reception point (TRP), where a TRP may transmit one or more beams. FIG. 4 provides an illustration of an embodiment of a system 400 demonstrating NR beam-based positioning available since 3GPP Release 16. The system 400 comprises a location server or LMF 410, a first gNodeB TRP 420, a second gNodeB TRP 430, a third gNodeB TRP 440 and a UE 450. The PRS can be transmitted by the different base stations 420, 430, 440 (serving and neighboring) using beams over frequency range/bands FR1 and FR2, which is relatively different when compared to LTE where the PRS was transmitted across the whole cell. The PRS can be locally associated with a PRS Resource ID and Resource Set ID for a base station (TRP). Similarly, UE positioning measurements such as reference signal time difference (RSTD) and PRS reference signal received power (RSRP) measurements are made on a per beam basis (e.g. based on downlink (DL) PRS resources or DL PRS resource sets) as opposed to different cells as was the case in LTE. In addition, there are additional UL positioning methods for the network to exploit in order to compute the target UE's location. Table 4 and Table 5 show the reference signal to measurements mapping required for each of the supported radio access technology (RAT)-dependent positioning techniques at the UE and the gNode-B, respectively. RAT-dependent positioning techniques involve the 3GPP RAT and core network entities to perform the position estimation of the UE, which are differentiated from the RAT-independent positioning techniques which rely on GNSS, IMU sensor, WLAN, and Bluetooth technologies for performing target device (UE) positioning.

TABLE 4

| | | To facilitate |
|---|---|---|
| | | support of |
| | | the following |
| DL/UL Reference | | positioning |
| Signals | UE Measurements | techniques |
| Rel.16 DL PRS | DL RSTD | DL-TDOA |
| Rel.16 DL PRS | DL PRS RSRP | DL-TDOA, |
| | | DL-AoD, |
| | | Multi-RTT |
| Rel.16 DL PRS/Rel.16 | UE Rx-Tx time | Multi-RTT |
| SRS for positioning | difference | |
| Rel. 15 SSB/CSI-RS | SS-RSRP(RSRP | E-CID |
| for RRM | for RRM), | |
| | SS-RSRQ(for RRM), | |
| | CSI-RSRP (for RRM), | |
| | CSI-RSRQ (for RRM), | |
| | SS-RSRPB (for RRM) | |

TABLE 5

| | | To facilitate support of |
|---|---|---|
| DL/UL Reference | gNode-B | the following positioning |
| Signals | Measurements | techniques |
| Rel.16 SRS for positioning | UL RTOA | UL-TDOA |
| Rel.16 SRS for positioning | UL SRS-RSRP | UL-TDOA, UL-AoA, |
| | | Multi-RTT |
| Rel.16 SRS for positioning, | gNB Rx-Tx time | Multi-RTT |
| Rel.16 DL PRS | difference | |
| Rel.16 SRS for positioning, | AoA and ZoA | UL-AoA, Multi-RTT |

RAT-dependent positioning techniques that have been supported since 3GPP Release-16 (specification #38.305) are briefly introduced in the following paragraphs. The DL-TDOA positioning method makes use of the DL RSTD (and optionally DL PRS RSRP) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

The DL AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

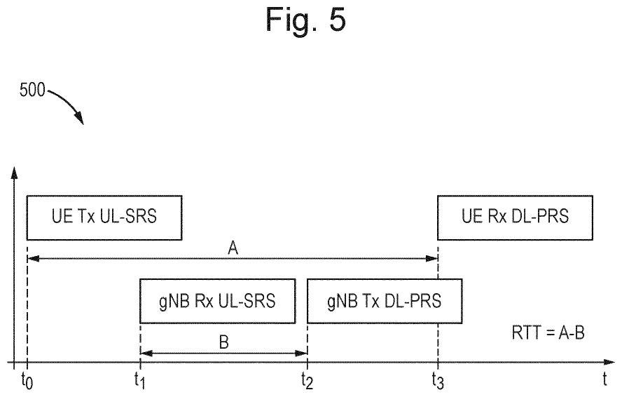

The Multi-cell RTT positioning procedure 500 is illustrated in FIG. 5 and makes use of the UE Rx-Tx measurements and DL PRS RSRP of downlink signals received from multiple TRPs, measured by the UE and the measured gNB Rx-Tx measurements and UL SRS-RSRP at multiple TRPs of uplink signals transmitted from UE. The UE measures the UE Rx-Tx measurements (and optionally DL PRS RSRP of the received signals) using assistance data received from the positioning server, and the TRPs measure the gNB Rx-Tx measurements (and optionally UL SRS-RSRP of the received signals) using assistance data received from the positioning server. The measurements are used to determine the RTT at the positioning server which are used to estimate the location of the UE. Multi-RTT is only supported for UE-assisted/NG-RAN assisted positioning techniques as noted in Table 3. FIG. 6 provides an illustration 600 of relative range estimation using the existing single gNodeB RTT positioning framework. Shown in the figure is a positioning server 610 (an LMF), a gNodeB 620, and a plurality of target UEs 630. Relative range 640 can be calculated between UEs 630 and a RTT can be computed 650 to obtain absolute location. Signals 660 are illustrated for UL-SRS 661, DL-SRS 662 in addition to relative UE-to-UE distance/orientation 670.

In the Enhanced Cell ID (CID) positioning method, the position of an UE is estimated with the knowledge of its serving ng-eNB, gNB and cell and is based on LTE signals. The information about the serving ng-eNB, gNB and cell may be obtained by paging, registration, or other methods. NR Enhanced Cell ID (NR E CID) positioning refers to techniques which use additional UE measurements and/or NR radio resource and other measurements to improve the UE location estimate using NR signals. Although NR E-CID positioning may utilize some of the same measurements as the measurement control system in the RRC protocol, the UE generally is not expected to make additional measurements for the sole purpose of positioning; i.e., the positioning procedures do not supply a measurement configuration or measurement control message, and the UE reports the measurements that it has available rather than being required to take additional measurement actions.

The UL TDOA positioning method makes use of the UL TDOA (and optionally UL SRS-RSRP) at multiple RPs of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

The UL AoA positioning method makes use of the measured azimuth and the zenith of arrival at multiple RPs of uplink signals transmitted from UE. The RPs measure A-AoA and Z-AoA of the received signals using assistance data received from the positioning server, and the resulting measurements are used along with other configuration information to estimate the location of the UE.

According to 3GPP Release-16, the PRS can be transmitted by different base stations (serving and neighboring) using narrow beams over frequency bands FR1 and FR2, which is relatively different when compared to LTE where the PRS was transmitted across the whole cell. The PRS can be locally associated with a PRS Resource ID and Resource Set ID for a base station (TRP). Similarly, UE positioning measurements such as Reference Signal Time Difference (RSTD) and PRS RSRP measurements are made between beams (e.g., between a different pair of DL PRS resources or DL PRS resource sets) as opposed to different cells as was the case in LTE. In addition, there are additional UL positioning methods for the network to exploit in order to compute the target UE's location.

The different DL measurements including DL PRS-RSRP, DL RSTD and UE Rx-Tx Time Difference required for the supported RAT-dependent positioning techniques are shown in Table 6. The measurement configurations specified in 3GPP specification #38.215 include: 4 Pair of DL RSTD measurements can be performed per pair of cells, each measurement is performed between a different pair of DL PRS Resources/Resource Sets with a single reference timing; 8 DL PRS RSRP measurements can be performed on different DL PRS resources from the same cell.

TABLE 6
DL PRS reference signal received power (DL PRS-RSRP)

| | |
|---|---|
| Definition | DL PRS reference signal received power (DL PRS-RSRP), is defined |
| | as the linear average over the power contributions (in W) of the |
| | resource elements that carry DL PRS reference signals configured |
| | for RSRP measurements within the considered measurement |
| | frequency bandwidth. |
| | For frequency range 1, the reference point for the DL PRS-RSRP |
| | shall be the antenna connector of the UE. For frequency range 2, |
| | DL PRS-RSRP shall be measured based on the combined signal |
| | from antenna elements corresponding to a given receiver branch. |
| | For frequency range 1 and 2, if receiver diversity is in use by the UE, |
| | the reported DL PRS-RSRP value shall not be lower than the |
| | corresponding DL PRS-RSRP of any of the individual receiver |
| | branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative |
| | timing difference between the positioning node j and the reference |
| | positioning node i, defined as TSubframeRxj − TSubframeRxi, |
| | Where: |
| | TSubframeRxj is the time when the UE receives the start of one |
| | subframe from positioning node j. |
| | TSubframeRxi is the time when the UE receives the corresponding |
| | start of one subframe from positioning node i that is closest in time |
| | to the subframe received from positioning node j. |
| | Multiple DL PRS resources can be used to determine the start of |
| | one subframe from a positioning node. |
| | For frequency range 1, the reference point for the DL RSTD shall |
| | be the antenna connector of the UE. For frequency range 2, the |
| | reference point for the DL RSTD shall be the antenna of the UE. |
| Applicable for | RRC_CONNECTED intra-frequency |
| | RRC_CONNECTED inter-frequency |

UE Rx-Tx time difference

| | |
|---|---|
| Definition | The UE Rx - Tx time difference is defined as TUE-RX − TUE-TX |
| | Where: |
| | TUE-RX is the UE received timing of downlink subframe #i from a |
| | positioning node, defined by the first detected path in time. |
| | TUE-TX is the UE transmit timing of uplink subframe #j that is |
| | closest in time to the subframe #i received from the positioning |
| | node. |
| | Multiple DL PRS resources can be used to determine the start of |
| | one subframe of the first arrival path of the positioning node. |
| | For frequency range 1, the reference point for TUE-RX |
| | measurement shall be the Rx antenna connector of the UE and the |
| | reference point for TUE-TX measurement shall be the Tx antenna |
| | connector of the UE. For frequency range 2, the reference point for |
| | TUE RX measurement shall be the Rx antenna of the UE and the |
| | reference point for TUE TX measurement shall be the Tx antenna |
| | of the UE. |
| Applicable for | RRC_CONNECTED intra-frequency |
| | RRC_CONNECTED inter-frequency |

RAT-independent positioning techniques that rely on GNSS, IMU sensor, WLAN and Bluetooth technologies for performing target device (UE) positioning are briefly introduced in the following paragraphs (3GPP specification #38.305).

Network-assisted GNSS methods make use of UEs that are equipped with radio receivers capable of receiving GNSS signals. In 3GPP specifications the term GNSS encompasses both global and regional/augmentation navigation satellite systems. Examples of global navigation satellite systems include GPS, Modernized GPS, Galileo, GLONASS, and BeiDou Navigation Satellite System (BDS). Regional navigation satellite systems include Quasi Zenith Satellite System (QZSS) while the many augmentation systems, are classified under the generic term of Space Based Augmentation Systems (SBAS) and provide regional augmentation services. Different GNSSs (e.g. GPS, Galileo, etc.) can be used separately or in combination to determine the location of a UE.

Barometric pressure sensor positioning makes use of barometric sensors to determine the vertical component of the position of the UE. The UE measures barometric pressure, optionally aided by assistance data, to calculate the vertical component of its location or to send measurements to the positioning server for position calculation. This method should be combined with other positioning methods to determine the 3D position of the UE.

The WLAN positioning method makes use of the WLAN measurements (AP identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Alternatively, the UE makes use of WLAN measurements and optionally WLAN AP assistance data provided by the positioning server, to determine its location.

The Bluetooth positioning method makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g. WLAN) to improve positioning accuracy of the UE.

A Terrestrial Beacon System (TBS) consists of a network of ground-based transmitters, broadcasting signals only for positioning purposes. The current type of TBS positioning signals are the MBS (Metropolitan Beacon System) signals and Positioning Reference Signals (PRS) (3GPP specification #36.211). The UE measures received TBS signals, optionally aided by assistance data, to calculate its location or to send measurements to the positioning server for position calculation.

The motion sensor positioning method makes use of different sensors such as accelerometers, gyros, magnetometers, to calculate the displacement of UE. The UE estimates a relative displacement based upon a reference position and/or reference time. UE sends a report comprising the determined relative displacement which can be used to determine the absolute position. This method should be used with other positioning methods for hybrid positioning.

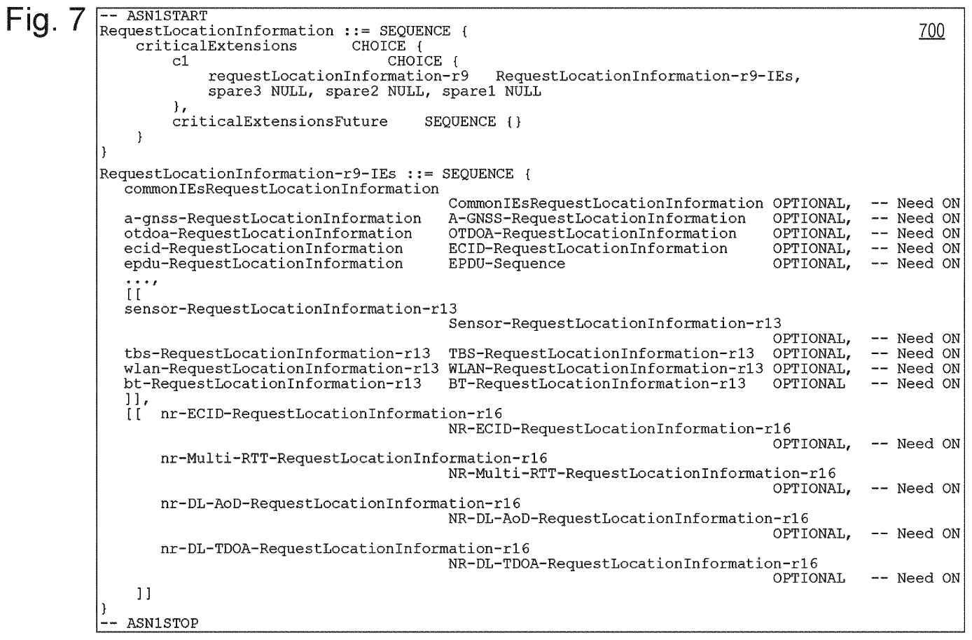

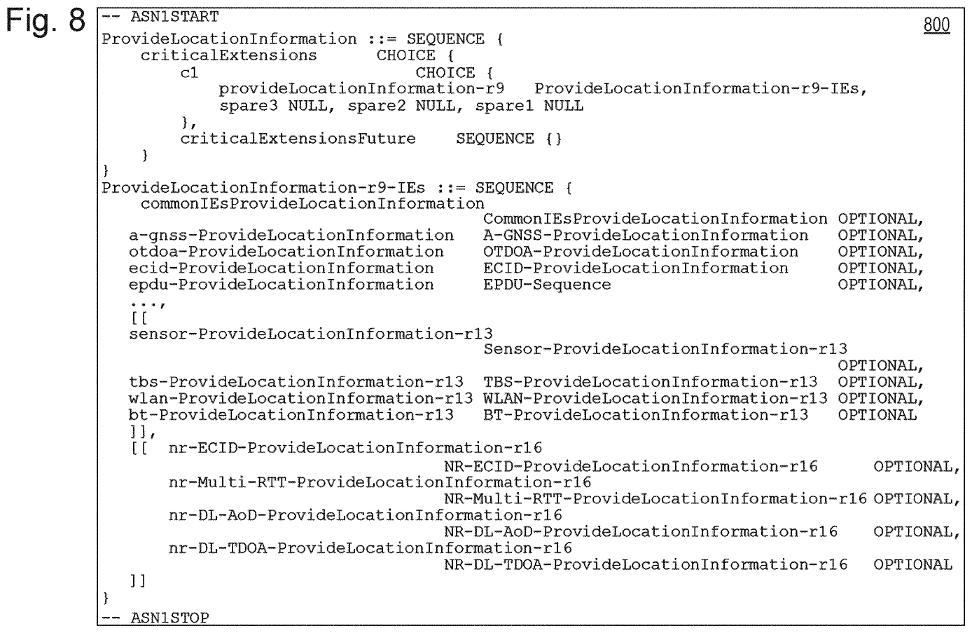

Measurement and reporting are performed per configured RAT-dependent/RAT-independent positioning method. The overall measurement configuration and reporting is illustrated in FIG. 7 and FIG. 8. In particular FIG. 7 provides an illustration 700 of the RequestLocationInformation message body in a LPP message used by a location server to request positioning measurements or a position estimate from a target device such as a UE 102. FIG. 8 provides an illustration 800 of an embodiment of the ProvideLocationInformation message body in a LPP message used by a target device (such as a UE 102) to provide positioning measurements or position estimates to a location server.

AI/ML offers opportunities for positioning accuracy enhancement within a wireless communication network. Some opportunities and use cases will now be briefly introduced as follows.

Direct AI/ML positioning where the output of AI/ML model inference is the UE location (examples include fingerprinting based on channel observation as an input to the AI/ML model; FFS the details of channel observation as the input of an AI/ML model such as CIR, RSRP and/or other types of channel observation; FFS applicable scenario(s) and AI/ML model generalization aspect(s)).

AI/ML assisted positioning where the output of an AI/ML model inference is a new measurement and/or enhancement of existing measurement (for example LOS/NLOS identification, timing and/or angle or measurement, likelihood of measurement; FFS the details of input and output for corresponding AI/ML model(s); FFS applicable scenario(s) and AI/ML model generalization aspect(s).

Furthermore, there is the potential for 3GPP specification impact for aspects of AI/ML approaches for positioning accuracy enhancement including but not limited to AI/ML model training (training data type/size; training data source determination e.g. UE/PRU/TRP; assistance signaling and procedure for training data collection), AI/ML model indication/configuration (assistance signaling and procedure e.g. for model configuration; model activation/deactivation; model recovery/termination; model selection), AI/ML model monitoring and update (assistance signaling and procedure e.g. for model performance monitoring; model update/tuning), AI/ML model inference input (report/feedback of model input for inference e.g. UE feedback as an input for network side mode inference; model input acquisition and pre-processing; type/definition of model input), AI/ML model inference output (report/feedback of mode inference output; post-processing of model inference output), UE capability for AI/ML model(s) (e.g. for model training, model inference and model monitoring). However not all of these aspects may apply to all AI/ML approaches in particular use cases.

The opportunities and use cases discussed herein for improving positioning in wireless communication networks require evolution of certain aspects of positioning frameworks. There is no known method in the current and herein described positioning framework to select, trigger, and configure the collection of positioning data required for training a configured AI/ML positioning model. This includes both online and offline training of positioning data for particular AI/ML models. In addition, the types of data sources are key in order for the input training dataset to be statistically significant, which influences the accuracy of AI/ML models to be trained. The present application presents a solution this problem.

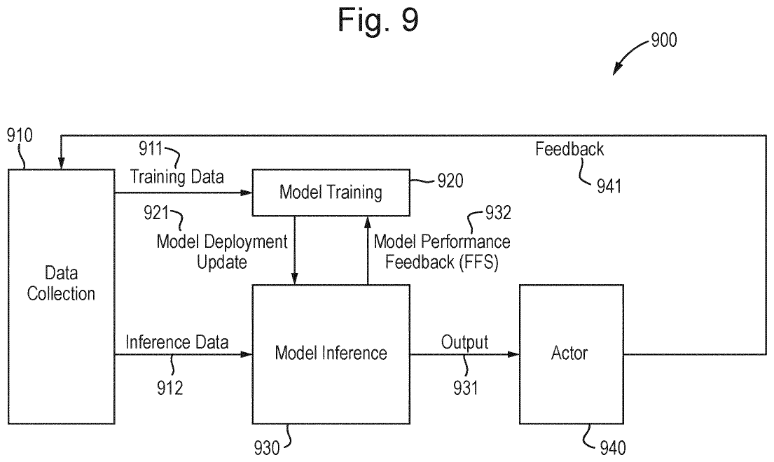

FIG. 9 provides an illustration of an embodiment of an AI/ML functional block diagram 900 in a functional framework for RAN intelligence. This introduces the common terminologies related to the functional framework for RAN intelligence. The functional block diagram 900 comprises data collection 910, model training 920, model inference 930 and actor 940.

Data collection 910 is a function that provides input data to model training 920 and model inference 930 functions. AI/ML algorithm specific data preparation (e.g., data pre-processing and cleaning, formatting, and transformation) is not carried out in the data collection 910 function. Examples of input data may include measurements from UEs or different network entities, feedback 941 from actor 940, output from an AI/ML model. Training data 911 is data needed as input for the AI/ML model training 920 function. Inference data 912 is data needed as input for the AI/ML model inference 930 function.

Model training 920 is a function that performs the ML model training, validation, and testing which may generate model performance metrics as part of the model testing procedure. The model training 920 function is also responsible for data preparation (e.g. data pre-processing and cleaning, formatting, and transformation) based on training data 911 delivered by a data collection 910 function, if required. Model deployment/update 921 is used to initially deploy a trained, validated, and tested AI/ML model to the model inference 930 function or to deliver an updated model to the model inference 930 function.

Model inference 930 is a function that provides AI/ML model inference output 931 (e.g. predictions or decisions). It is yet to be determined on whether it provides model performance feedback 932 to model training 920 function. The model inference 930 function is also responsible for data preparation (e.g. data pre-processing and cleaning, formatting, and transformation) based on inference data 912 delivered by a data collection 910 function, if required. Details of inference output 931 are use case specific. It is also yet to be determined on whether model performance feedback 932 is applied if certain information derived from the model inference 930 function is suitable for improvement of the AI/ML model trained in the model training 920 function. Feedback 941 from actor 940 or other network entities (via data collection 910 function) may be needed at the model inference 930 function to create model performance feedback 932.

Actor 940 is a function that receives the output 931 from the model inference 930 function and triggers or performs corresponding actions. The actor 940 may trigger actions directed to other entities or to itself. Feedback 941 is information that may be needed to derive training or inference data or performance feedback.

The network nodes and methods described herein provide for selection and configuration of data sources depending on the type of training of positioning data as well as which network entity is performing the training of the AI/ML positioning model.

Described herein is a network node in a wireless communication network, comprising: a transmitter arranged to send a positioning training dataset configuration to at least one data source of the wireless communication network, the positioning training dataset configuration comprising a request for a positioning training dataset for training a machine learning positioning model, and a required data format of the positioning training dataset based on a location of the network node. The network node further comprising a receiver arranged to receive a response from the at least one data source, the response comprising the positioning training dataset according to the required data format. The network node further comprising a processor arranged to train the machine learning positioning model using the positioning training dataset.

In some embodiments the at least one data source comprises a data source selected from the group of data sources consisting of: a serving or neighboring gNode B; a serving or neighboring transmit receive point; a positioning reference unit user equipment; a positioning reference unit transmit receive point; a reference user equipment; a target user equipment; an assistance user equipment; a third party user equipment; a network data analytic function; and a location management function.

In some embodiments the network node is selected from the group of network nodes consisting of: a location server node; a next generation radio access network node; a positioning reference unit gNode B; a positioning reference unit transmit receive point; a positioning reference unit user equipment; a reference user equipment; an assistance user equipment; a third party user equipment; and a target user equipment. The next generation radio access network node may comprise a serving or neighboring gNode-B, or a serving or neighboring transmit receive point. The serving or neighboring gNode-B may be applicable to terrestrial and/or non-terrestrial network.

In some embodiments the positioning training dataset configuration comprises a reporting configuration that is instantaneous, periodic, event-based, or a combination thereof.

In some embodiments the machine learning positioning model comprises a machine learning direct positioning model (for instance wherein the input positioning training data is provided to the machine learning model to output the target-UE's final location estimate) or a machine learning assisted positioning model (for instance wherein the input positioning training data is provided to the machine learning model to output an enhanced positioning-related measurement or metric used to eventually compute the location estimate of the target-UE). Some machine learning positioning models may be used that can do both types of training (direct and assisted). However, the trained data used to develop the machine learning positioning model may be different depending on whether the model is direct or assisted.

In some embodiments the required data format is structured according to a type of the machine learning positioning model.

In some embodiments the required data format comprises a fingerprint number, a positioning measurement, a configurable location information of a location at which the positioning measurement is performed, a time information of the positioning measurement, a quality of the positioning measurement, or any combination thereof. The configurable location information may comprise at least one of: a 2D or 3D coordinate; a zone identifier; a grid identifier; a speed or velocity; an orientation; a heading; a height; a rectangular grid having a length and width. The coordinates may include geodesic or spherical coordinates. The length and width may be configured depending on location accuracy granularity.

In some embodiments the receiver is further arranged to receive an activation request for activating the sending of the positioning training dataset configuration, the receiving of the positioning training dataset and/or the training of the machine learning positioning model.

In some embodiments the receiver is further arranged to receive a deactivation request for deactivating the sending of the positioning training dataset configuration, the receiving of the positioning training dataset and/or the training of the machine learning positioning model.

In some embodiments the transmitter is further arranged to transmit an output of the trained machine learning positioning model to a first network node.

In some embodiments the processor is further arranged to train the machine learning positioning model using a positioning training dataset received from a local data source.

In some embodiments the training dataset configuration further comprises an indication as to whether the positioning training dataset is intended for online and/or offline training of the machine learning positioning model.

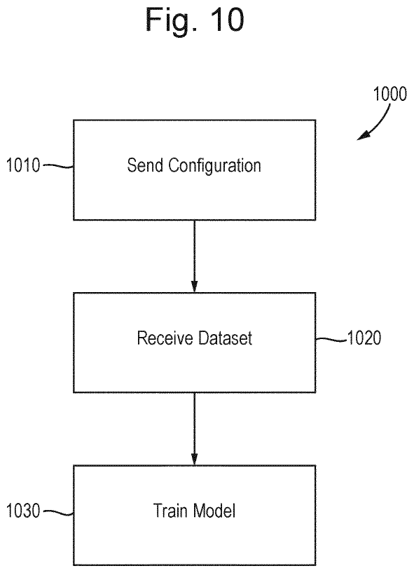

FIG. 10 provides an illustration of an embodiment of a method 1000 in a network node in a wireless communication network. In a first step 1010 a positioning training dataset configuration is sent to at least one data source of the wireless communication network, the positioning training dataset configuration comprising a request for a positioning training dataset for training a machine learning positioning model, and a required data format of the positioning training dataset based on a location of the network node. In a second step 1020, a response is received from the at least one data source, the response comprising the positioning training dataset according to the required data format. In a third step 1030, a machine learning positioning model is trained using the positioning training dataset.

In some embodiments the at least one data source comprises a data source selected from the group of data sources consisting of: a serving or neighboring gNode B; a serving or neighboring transmit receive point; a positioning reference unit user equipment; a positioning reference unit transmit receive point; a reference user equipment; a target user equipment; an assistance user equipment, a 3^{rd} party user equipment; a network data analytic function; a location management function.

In some embodiments the network node is selected from the group of network nodes consisting of: a location server node; a next generation radio access network node; a positioning reference unit gNode B; a positioning reference unit transmit receive point; a positioning reference unit user equipment; an assistance user equipment; a 3^{rd} party user equipment; a reference user equipment; and a target user equipment. The next generation radio access network node may comprise a serving or neighboring gNode-B, or a serving or neighboring transmit receive point.

In some embodiments the positioning training dataset configuration comprises a reporting configuration that is instantaneous, periodic, event-based, or a combination thereof.

In some embodiments the machine learning positioning model is a machine learning direct positioning mode or a machine learning assisted positioning model.

In some embodiments the required data format is structured according to a type of the machine learning positioning model.

In some embodiments the required data format comprises a fingerprint number, a positioning measurement, a configurable location information of a location at which the positioning measurement is performed, a time information of the positioning measurement, a quality of the positioning measurement, or any combination thereof.

In some embodiments the configurable location information comprises at least one of: a 2D or 3D coordinate; a zone identifier; a grid identifier; a speed or velocity; an orientation; a heading; a height; a rectangular grid having a length and width.

Some embodiments further comprise receiving an activation request for activating the sending of the positioning training dataset configuration, the receiving of the positioning training dataset and/or the training of the machine learning positioning model.

Some embodiments further comprise receiving a deactivation request for deactivating the sending of the positioning training dataset configuration, the receiving of the positioning training dataset and/or the training of the machine learning positioning model.

Some embodiments further comprise the step of transmitting an output of the trained machine learning positioning model to a first network node.

Some embodiments further comprise the step of training the machine learning positioning model using a positioning training dataset received from a local data source. A local data source may be a data source at the network node, such as stored positional measurement information, or a local data source may comprise the obtaining of positional information and/or measurements by the network node (for instance if the network node is a UE or a gNodeB).

In some embodiments the training dataset configuration further comprises an indication as to whether the positioning training dataset is intended for online and/or offline training of the machine learning positioning model.

FIG. 11 illustrates an embodiment of a system 1100 showing entities/nodes within a positioning network setup capable of performing AI/ML training using positioning input data in a wireless communication network. The entities/nodes may also serve as configured data sources for providing positioning training datasets to other entities/nodes. The system 1100 comprises an LCS client 1110 and an application function 1120, a 5G core network 1130, a radio access network (NG-RAN) 1140, a target-UE 11500 and LCS client 1151, and a PRU-UE 1160. The 5G core network 1130 comprises a GMLC/LRF 1131, a UDM 1132, a NEF 1133, a AMF 1134 and an LMF 1135. The radio access network 1140 comprises a first neighboring gNodeB 1141, a second neighboring gNodeB 1142, a serving gNodeB 1143 and a PRU as a TRP 1144. The LMF 1135 of the 5G core network 1130 may perform LMF training using a positioning dataset. The gNodeB 1141, 1142, 1143 may perform training using a positioning dataset. The target-UE 1150 may perform training using a positioning dataset. The PRU UE 1160 may perform training using a positioning dataset. The PRU TRP 1144 may perform training using a positioning dataset.

Embodiments where the LMF 1135 performs the training of a machine learning positioning model using a positioning training dataset will now be described in more detail. The LMF 1135 is supported to request the training data set from one or more configured data sources. In another implementation, the LMF 1135 may request the partial training data set from data source A and another partial training data set from data source B. The configured data sources may be one or more of the following entities including: serving and/or neighboring gNode-Bs/TRPs, such as 1141, 1142, 1143, 1144; positioning reference unit as a UE and/or TRP, such as 1160 and 1144; a reference UE; or a NWDAF.

The serving and/or neighboring gNBs/TRPs such as 1141, 1142, 1143, 1144, may act as data sources and provide the training dataset in the form of UL-based positioning measurements comprising of UL-RTOA, gNB Rx-Tx time difference measurements, UL-AoA (including LCS-to-GCS translation information), SRS-RSRP and SRS-RSRPP (per path RSRP). The training dataset should comprise of ground truth measurements including at least location information associated to each of the measurements, of which the quality of measurements may vary depending on the type of training, e.g., online positioning training data may require different location granularity and update intervals when compared to positioning data that was trained in an offline manner.

In another implementation option, PRU TRPs such as 1144 may also act as data sources and be distributed evenly across different indoor/outdoor scenarios such that the ground truth measurements of each area of the indoor/outdoor scenario is captured based on the fixed location of the deployed PRU TRPs such as 1144, e.g., an example of such a scenario may include an IIOT indoor factory scenarios with TRPs deployed in a distributed manner across the whole area of the factory floor.

PRU as a UE 1160 may also act as a data source to collect ground truth measurements including DL-based measurements such as RSTD, UE Rx-Tx time difference measurements, PRS RSRP, PRS RSRPP (per path RSRP), and UE based on different configured location granularities. may be applicable to both offline and online training of the AI/ML model. Similarly, reference UEs may also collect information pertinent for the training dataset in terms of pre-classifying measurements as LOS and/or NLOS. This may be also applicable to both offline and online training of the AI/ML model.

Normal positioning UEs (also referred to as target-UEs) may also be configured to provide positioning training data in a best effort manner in order to update the offline training database of measurements. This can be applicable to the case when the AI/ML model may need to be updated based on the real time environmental changes to the measurements that were not captured during the offline training phase.

The type of location information associated to each positioning measurement of the training dataset may comprise of one or more of the following: 2D (x,y) or 3D (x, y, z) coordinates of the UE including geodesic or spherical or latitude/longitude coordinates; Zone ID/Grid ID; UE Speed/velocity; orientation; heading; height; antenna array location information.

In extended implementations, the configured data sources may be provided with the location information based on e.g., RAT-independent positioning measurements/methods such as GNSS, Bluetooth, WiFi, Inertial Measurement Units (IMU), e.g., accelerometer, gyroscope.

FIG. 12 illustrates an embodiment 1200 of LMF based collection and training of positioning measurement data including systematic signaling procedures for location server 1210 (LMF)-based training. The configured data sources may be one or more of the following entities including serving and/or neighboring gNBs/TRPs 1220, positioning reference unit as a TRP 1230, positioning reference unit as a UE 1240, reference UE 1250, target-UE 1260. In some implementations separate measurement configuration for the purposes of AI/ML positioning may be configured to the aforementioned data sources, which may be different to measurement configuration for non-AI/ML positioning methods. These may include the type of positioning methods, different PRS configuration including different comb-pattern, number of symbols, repetitions, QCL assumptions, muting configuration, periodicity, or combination thereof.

The steps in the embodiment 1200 of LMF based collection and training of positioning measurement data will now be described.

In a first step 1201 a request of training data (ground truth data collection) is made. In this step 1201 the location server node 1210 (e.g., LMF) requests training data set from the NG-RAN nodes 1220 and 1230 including an indication, whether the requested training data (measurement data) is used for offline and/or online training and location for each measurement. This request may include a request for RAT-independent and UL-based positioning measurements. This request may be signaled using the NRPPa interface. In a further step 1202 the location server node 1210 (e.g., LMF) requests the training data set from the UE nodes (PRU UE 1240, Reference UE 1250 and/or target-UE 1260) including an indication, whether the requested training data (measurement data) is used for offline and/or online training and location for each measurement. This request may include RAT-independent and DL-based positioning measurements. This request may be signaled using LPP.

In a further step 1203 The UE nodes 1240, 1250, 1260, perform measurements over a period of time that provides statistical significance for each location or is ready to provide stored measurements with requested timestamps and locations of each stored location.

In a further step 1204, gNB nodes 1220 and 1230 perform measurements over a period of time that provides statistical significance for each location or is ready to provide stored measurements with requested timestamps and locations of each stored location.

In a further step 1205, UE nodes 1240, 1250, 1260, respond with a set of structured training data comprising of measurements and location of each measurement. This response may be signaled using LPP.

In a further step 1206, gNB nodes 1220 and 1230 respond with a set of structured training data comprising of measurements and timestamp/location of each measurement. This response may be signaled using NRPPa.

In a further step 1207 the LMF 1210 performs training using collected data from the data sources.

In an alternative extended implementation, the type of learning and AI/ML models for positioning may also be signaled in conjunction with the data collection configurations. These may include: type of learning model, e.g., unsupervised or supervised learning, clustering, classification, dimension reduction, regression. These may further include type of AI/ML model, e.g., deep neural network, support vector machine (SVM), k-nearest neighbor (KNN) classifier or the like.

According to some embodiments, the NG-RAN node and/or PRU as a TRP is supported to request the training data set from one or more of the configured data sources. The training at the NG-RAN node and/or PRU as a TRP offers the opportunity to use both RAT-independent positioning measurement and UL-based positioning measurement data to train an AI/ML model at the gNB side, which can save on training dataset signaling overhead depending on the scenario. FIG. 13 illustrates an embodiment 1300 of NG-RAN node-based training and signaling.

The configured data sources may be one or more of the following entities including positioning reference unit as UE 1330, reference UE 1340, target UE 1350. In another implementation, the NG-RAN node 1320 may separately request for positioning datasets from the LMF 1310 including measurements/data received from other cells as additional information.

The steps in the embodiment 1300 of NG-RAN node based training are as follows.

In a first step 1301 the LMF 1310 may activate the collection and training of the positioning AI/ML model at the desired NG-RAN node/PRU TRP 1320. This may include requesting an output of the trained model. This step 1301 may be signaled using NRPPa.

In a further step 1302 the NG-RAN node 1320 may request for the collection of positioning training data from the configured data sources (such as UEs 1330, 1340, 1350), which may include RAT-independent positioning measurements/location estimates as well as SRS configurations for the UE to transmit SRS for the purposes of measurement collection and training at the NG-RAN node 1320. This request may use RRC.

In a further step 1303, a response to NG-RAN's 1320 request is provided by the UE (such as 1330, 1340, 1350) including reporting RAT-independent positioning measurements/location estimates, e.g., GNSS reported using MDT, RAT-independent location information reported using the RRC CommonLocationInfo message as well as the transmission of SRS for positioning. In another implementation, timing information, e.g., in the form of timestamp, in addition to the location information at which SRS was transmitted could also be reported along with the data point comprising location information.

In a further step 1304, the NG-RAN nodes 1320 performs and collects measurements.

In a further step 1305, NG-RAN node 1320 performs training of the collected measurements.

In a further step 1306, NG-RAN node 1320 may transfer the output of the trained model depending on the type of AI/ML positioning task, e.g, for Direct AI/ML positioning or AI/ML assisted positioning. This output may be a location estimate or an enhanced measurement result. This output may use NRPPa.

In a further step 1307, the LMF 1310 may de-activate the collection and training of the AI/ML model for positioning. This deactivation may use NRPPa.

In some embodiments, the PRU-UE and target-UE node is supported to request the positioning training data from one or more of the configured data sources. The training at the PRU UE as a node offers the opportunity to perform extensive ground truth collection including measurements and associated locations. In another aspect, performing training for a target-UE supported UE-based positioning methods may assist in updating the ground truth positioning database at certain locations in which the UE reports measurements. FIG. 14 provides an illustration of an embodiment 1400 of UE-based collection and training of positioning data and systematic signaling procedures for UE node-based training of positioning. The configured data sources may be one or more of the following entities including target UE 1410, PRU UE 1420, other UE 1440 including reference UE 1430, location server (LMF) 1450. The steps illustrated in the embodiment 1400 are as follows.

In a first step 1401 the UE 1410, 1420, 1430 may perform configured SL (PC5)/DL PRS measurements over a specific period and location and/or use stored SL (PC5)/DL PRS measurements from the past (based on historical measurements, the period of past historical measurements may also be further configured during the training phase).

In a further step 1402, the UE 1410, 1420, 1430 may request other UEs/PRU UEs 1440 for positioning training data (comprising of SL or DL positioning measurements or combination thereof) using the PC5 interface. The positioning training dataset may be based on online/offline training RAT independent and DL-based positioning measurements.

In a further step 1403, the UE 1410, 1420, 1430, may request the LMF 1450 for positioning training data using the LPP interface. The positioning training data may include DL and/or SL measurements, if available. The request for positioning training dataset may be based on online/offline training.

In a further step 1404, the UE 1410, 1420, 1430 receives a response with the requested measurements/positioning data from the other surrounding/nearby UEs 1440. In a different response, the UE 1410, 1420, 1430 may receive an indication that the requested training dataset is unavailable or will be available in period of time/time instance in the future. The response may use the PC5 interface.

In a further step 1405, the UE 1410, 1420, 1430 receives a response with the requested measurements/positioning data from the LMF 1450. In a different response, the UE 1410, 1420, 1430 may receive an indication that the requested training dataset is unavailable or will be available in period of time/time instance in the future. The response may use the LPP interface.

In a further step 1406, the UE 1410, 1420, 1430 performs training based on the collected data from the configured data sources.

In other implementations, the positioning data to be collected may comprise of DL-based or SL-based measurements or a combination of thereof.

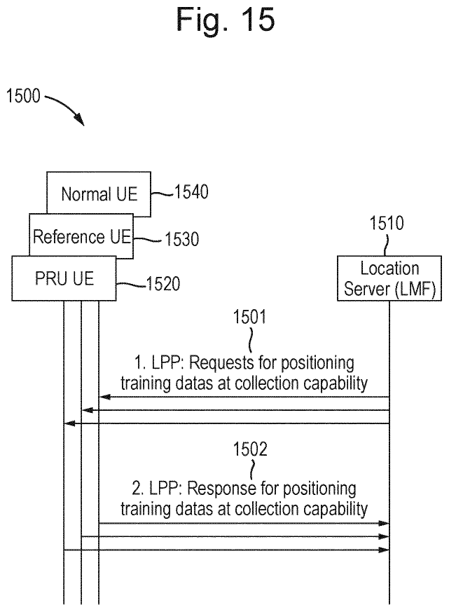

In some embodiments, service request triggers for performing positioning data collection are used. Since the LMF/NG-RAN node/UE are the consumers of the measurement data for the purposes of AI/ML training, a separate AI/ML positioning data collection service request should be managed by the LMF. Due to the varying nodes in which the training may be performed a common framework for data collection should be established, where the LMF may act as the centralized coordinating entity. According to FIG. 13, in the case of NG-RAN node 1320 training, the LMF 1310 may activate 1301 and deactivate 1307 collection of positioning data as well as training of the AI/ML model at the NG-RAN node 1320. In a similar manner, for all the embodiments described herein, the LMF may initiate the configuration of data sources for the purposes of training data collection. The data sources may be identified via a separate capability that confirms the UE's ability to collect positioning data/measurements for the purposes of AI/ML model training. FIG. 15 illustrates an exemplary depiction 1500 of such a request and response for positioning training data set collection.

In a first step 1501, a location server (LMF) 1510 requests positioning training dataset collection capability from at least one data source which may include a PRU UE 1520, a reference UE 1530, a normal UE 1540. The request may use the LPP interface.

In a further step 1502, the UE 1520, 1530, 1540, provides a response to the LMF 1510 with positioning training dataset collection capability. The response may use the LPP interface.

In an extended implementation, the capability request 1501 and response 1502 differentiate the ability to collect training data for online and/or offline training, support for Direct AI/ML methods (e.g., Fingerprinting), AI/ML-assisted methods (AI/ML assisted DL-TDOA, AOD, RTT), provide known locations and associated location determination sources. In another implementation, these capabilities may be requested and responded per positioning method for AI/ML and non-AI/ML positioning methods. Non-AI/ML methods, refer to positioning methods requiring no AI/ML support.

The data collection reporting configuration may be designed according to the following types of reporting (which may also be requested by the LMF 1510). Immediate (instantaneous) positioning data collection reports: based on an immediate request from the LMF 1510 with a configured response time or the LMF 1510 may configure the UE 1520, 1530, 1540 to store all measurements and ground truth for a certain time period (e.g., 24 hrs), then UE 1520, 1530, 1540 may report all data to the LMF 1510 upon request. Periodic data collection reports: based on a reporting interval and reporting amount parameters or the period for measurements/logs and the period for reporting could be same or different. Event-based data collection reports: based on an event change scenario, e.g., the UE 1540 moves to a new positioning area with a different area ID or when the PRU UE 1520 moves another 10 cm or 1 cm away from the last position which has been reported to LMF 1510.

The structure of an embodiment of a positioning training dataset will now be described, which may facilitate different AI/ML-based positioning schemes including Direct AI/ML positioning, e.g., using Fingerprinting and/or AI/ML-assisted positioning, e.g., intermediate positioning measurement optimization. Furthermore, the input training dataset structure varies according to the AI/ML model type and task (classification, prediction (regression algorithms)). The structure of the training dataset may affect the size of training dataset (e.g., payload) and the type of signaling to be configured to transfer such information, e.g., user-plane or control plane signaling. For the purposes of this solution, user-plane (new LCS user plane protocol) or control-plane signaling (e.g., LPP) may be configured to transfer the training dataset configuration.

The training dataset can be structured as N-dimensional database comprising of multiple features. In the case of Direct AI/ML positioning and/or AI/ML assisted positioning, a fingerprint database may be leveraged to directly determine the position of the UE.

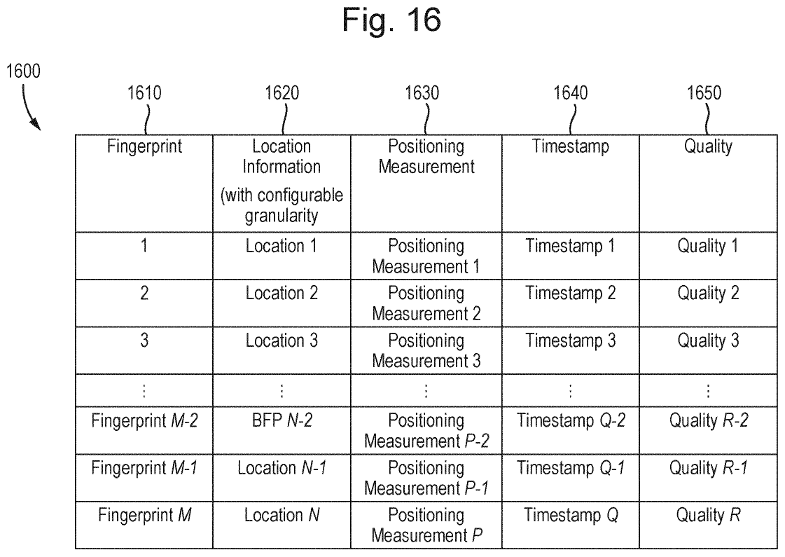

For example, in the case of AI/ML direct positioning the training database (dataset structure/configuration/required data format) may be exemplified as shown in FIG. 16. The AI/ML direction positioning training database structure 1600 is an N-dimensional database/configuration, where N is the number of column wise features/labels associated to a fingerprint, comprising a plurality of fingerprints 1610 and for each fingerprint 1610 there is provided location information 1620 (with configurable granularity); positioning measurement 1630; timestamp 1640; and quality 1650.

The positioning measurements 1630 may comprise at least one of the following (depending on if the UE or NG-RAN node performs the measurement): DL RSTD (DL-based measurements); DL PRS RSRP (DL-based measurements); DL PRS RSRPP (DL-based measurements); UE Rx-Tx time difference (DL-based measurements); SS-RSRP (RSRP for RRM); SS-RSRQ (for RRM); CSI-RSRP (for RRM); CSI-RSRQ (for RRM); SS-RSRPB (for RRM) (DL-based measurements); UL RTOA (UL-based measurements); UL SRS-RSRP (UL-based measurements); UL SRS-RSRPP (UL-based measurements); UL RTOA (UL-based measurements); gNB Rx-Tx time difference UL RTOA (UL-based measurements); UL-AoA and UL-ZoA UL RTOA (UL-based measurements).

In the case of UL-based measurements, the UE location of SRS transmission may also be provided. The timestamps 1640 can be implemented using defined time bases in units of milliseconds, seconds, minutes, hours or the like. Furthermore, in other implementations, absolute time units may also be used, e.g, UTC time, etc.

The database 1600 may be signaled using either control-plane or user-plane signaling. In the case of control plan signaling, exemplary signaling mechanisms may include LPP signaling and in the case user plane signal, new protocols may be used, e.g., LCUP (LCS User plane).

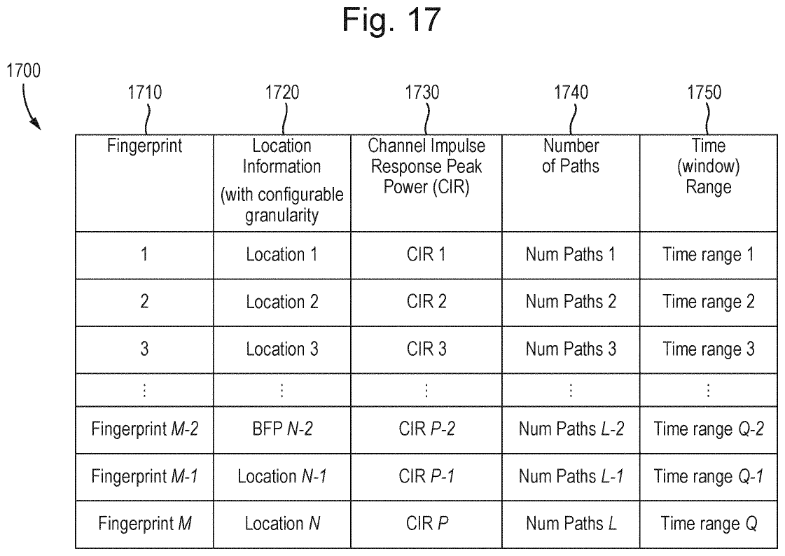

As a further example, in the case of AI/ML assisted positioning training database structure, an exemplification is illustrated in FIG. 17. The dataset structure/configuration/required data format 1700 comprises a plurality of fingerprints 1710 and for each fingerprint: location information 1720 (with configurable granularity); channel impulse response peak power (CIR) 1730; number of paths 1740; time (window) range 1750. The features of the channel impulse response 1730 are extracted in terms of generating the ground truth measurements.

The location 1720 may be a specific point in 2D or 3D space, while in another implementation, the location 1720 may comprise of the 2D or 3D rectangular grid with length L and width W and height H, where L and W and H may be configured depending on the location accuracy granularity.

It is desired to study a 3GPP framework for AI/ML for air-interface corresponding to each target use case including CSI feedback, beam management and positioning accuracy enhancements regarding aspects such as performance, complexity, and potential specification impact. There is no known method in the current positioning framework to select, trigger and configure the collection of positioning data required for training a configured AI/ML positioning model. This includes both online and offline training of positioning data for a particular AI/ML model depending on the network entity performing the training. In addition, the types of data sources and methods of collection are a key component in order for the input training dataset to be statistically significant, which influences the accuracy of the AI/ML model.

The training of the AI/ML positioning model may be supported in a variety of scenarios in which different network entities may request for positioning dataset(s) and then subsequently train the AI/ML model. Procedures are described wherein the network entity or node performing the training may configure and request for the positioning dataset depending on a set of defined criteria, i.e., based on AI/ML Direct and AI/ML assisted positioning methods. Methods are also presented wherein the LMF may be aware of nodes/entitles being able to perform positioning data collection, while also configuring the manner in which such data is reported. The next aspect of the invention describes a general structure for the positioning training dataset to be trained and signaled over the different interfaces, which is differentiated based on AI/ML Direct and AI/ML assisted positioning methods.

In DOI: 10.1109/OJVT.2021.3110134, some architectural enhancements related to data collection were discussed for AI/ML assisted positioning methods, however this relied on the existing MDT data collection procedures. MDT data collection procedures were designed with a different objective for network operation and maintenance and may not be well-suited or optimized for the type of AI/ML tasks required for UE positioning. In SMM920210198-US-PSPF, a measurement and reporting framework for 3GPP positioning was discussed but does not tackle the configuration of data sources according to the location of the training and the content of the training dataset. Currently, the deployment of training and inference models have been described in TR 37.817 in the context of 3GPP for use cases such as mobility optimization and load balancing, without considering any positioning-specific use cases for AI/ML model training and data collection.

As described herein, in one embodiment, a method for selection and configuration of data sources depending on the network entity performing the AI/ML training is described. These include AI/ML positioning training performed at the location server (LMF), NG-RAN node, PRU as UE or normal positioning UE and indication whether is training is online or offline, which affects the configuration and reporting of the positioning dataset collection. In another embodiment, a method for the LMF to configure the collection of AI/ML training data for positioning purposes is detailed, using different reporting methods, which can be configured based on the data collection scenario. In the final embodiment, a method to generate a training dataset depending on whether AI/ML direct (standalone) positioning or AI/ML assisted positioning is proposed, which will affect the structure of the training dataset to be signaled.

Aspects described herein relate to a method in a wireless communication network wherein: a network entity performing the training of the desired AI/ML positioning model configures at least one data source to provide a positioning training dataset; the positioning training dataset configuration may contain at least a request to the data source and format of the training dataset based on the location of the network entity performing the training of the AI/ML model for the purposes of positioning; a data source responds to the said dataset configuration by providing the required training dataset according to the desired data format; a network entity performing the training of the desired AI/ML model based on the collected training dataset.

In some embodiments the data source may comprise of a serving or neighboring gNBs/TRPs, Positioning Reference Unit UE or Positioning Reference Unit TRP, Reference UE, target-UE, other UEs or combination thereof.

In some embodiments the training dataset may be provided based on whether the training occurs at the at least one of a serving or neighboring gNBs/TRPs, Positioning Reference Unit UE or Positioning Reference Unit TRP, Reference UE, target-UE, other UEs.

In some embodiments the AI/ML positioning model may perform AI/ML Direct positioning or AI/ML assisted positioning.

In some embodiments the positioning training dataset configuration comprises a reporting configuration that may be either instantaneous, periodic, event-based or combination thereof.

In some embodiments the training dataset structure or database may be formatted according to the type of AI/ML positioning model, comprising AI/ML Direct positioning, AI/ML assisted positioning or combination thereof.

In some embodiments the network entity may be a positioning reference unit UE, reference UE, target-UE, reference UE, NG-RAN node, positioning reference unit gNB, location server or the like.

In some embodiments the NG-RAN node may comprise of a serving gNB or TRP, neighboring gNB or TRP.

In some embodiments the data format may comprise the fingerprint number, configurable location at which the positioning measurement was performed, positioning measurement, time information regarding the occurrence of the measurement, quality of the performed positioning measurement or combination thereof.

In some embodiments the training dataset configuration may include an indication on whether the data collection is intended for online and/or offline training of the machine learning positioning model.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations used herein would be apparent to a person skilled in the art:
ADR Accumulated Delta-Range
A GNSS Assisted GNSS
AI Artificial Intelligence
AP Access Point
ARFCN Absolute Radio Frequency Channel Number
ARP Antenna Reference Point
BFD Beam failure detection
BSSID Basic Service Set Identifier
BTS Base Transceiver Station (GERAN)
BWP Bandwidth Part
CBR Channel Busy Ratio
CG Configured Grant
CID Cell-ID (positioning method)
CRS Cell-specific Reference Signals
CSI Channel State Information
CSI-RS Channel State Information Reference Signal
DCI Downlink Control Information
DL Downlink
DL-AOD Downlink Angle-of-Departure
DL-TDOA Downlink Time Difference Of Arrival
DM-RS DeModulation Reference Signal
DS-TWR Double-sided Two Way Ranging
ECEF Earth-Centered, Earth-Fixed
ECGI Evolved Cell Global Identifier
E CID Enhanced Cell-ID (positioning method)
E-SMLC Enhanced Serving Mobile Location Centre
E-UTRAN Evolved Universal Terrestrial Radio Access Network
EOP Earth Orientation Parameters
EPDU External Protocol Data Unit
FDMA Frequency Division Multiple Access
FEC Forward Error Correction
FTA Fine Time Assistance
GAGAN GPS Aided Geo Augmented Navigation
GNSS Global Navigation Satellite System
GPS Global Positioning System
HA GNSS High-Accuracy GNSS (RTK, PPP)
IMU Inertial Measurement Unit
IS Interface Specification
LMC Location Management Component
LMF Location Management Function
LMU Location Measurement Unit
LOS Line-of-sight
LPP LTE Positioning Protocol
LPPa LTE Positioning Protocol Annex
LSB Least Significant Bit
MAC Master Auxiliary Concept
   Medium Access Control
MAC CE Medium Access Control Element
MBS Metropolitan Beacon System
ML Machine Learning
MO-LR Mobile Originated Location Request
MSB Most Significant Bit
MT-LR Mobile Terminated Location Request
Multi-RTT Multiple-Round Trip Time
NAV Navigation
NB-IOT NarrowBand Internet of Things
NCGI NR Cell Global Identifier
NI-LR Network Induced Location Request
NLOS Non-line-of-sight
NPRS Narrowband Positioning Reference Signals
NR NR Radio Access
NRPPa NR Positioning Protocol Annex
NRSRP Narrowband Reference Signal Received Power
NRSRQ Narrowband Reference Signal Received Quality
NWDAF Network Data Analytics Function
OSR Observation Space Representation
OTDOA Observed Time Difference Of Arrival
PDU Protocol Data Unit
PDCP Packet Data Convergence Protocol
PDCCH Physical Downlink Control Channel
PDSCH Physical Downlink Shared Channel
PHY Physical Layer
PSCCH Physical Sidelink Control Channel
PSSCH Physical Sidelink Shared Channel
PSBCH Physical sidelink broadcast channel
PPP Precise Point Positioning
PRB Physical Resource Block
PRC Pseudo Range Correction
PRS Positioning Reference Signals
posSIB Positioning System Information Block
P-RNTI Paging-Radio Network Temporary Identifier
PT-RS Phase Tracking Reference Signal
PUCCH Physical Uplink Control Channel
PUSCH Physical Uplink Shared Channel
QCL Quasi Co-Location
RAT Radio Access Technology
RF Radio Frequency
RLC Radio Link Control
RRC Range Rate Correction
Radio Resource Control
RRM Radio Resource Management
RS Reference Signal
RSRP Reference Signal Received Power
RSRPP Per Path Reference Signal Received Power
RSRQ Reference Signal Received Quality
RSTD Reference Signal Time Difference
RSU Roadside Unit
RTK Real-Time Kinematic
RTT Round Trip Time
SBAS Space Based Augmentation System
SBCH Sidelink Broadcast Channel
SCCH Sidelink Control Channel
SCI Sidelink Control Information
SET SUPL Enabled Terminal
SFN System Frame Number
SL Sidelink
SL-PRS Sidelink Positioning Reference Signal
SLP SUPL Location Platform
SPS Semi-Persistent
SS/PBCH Synchronization Signal/Physical Broadcast Channel
SSBRI SS/PBCH Block Resource Index
SSID Service Set Identifier
SSR State Space Representation
SS-TWR Single-sided Two Way Ranging
STCH Sidelink Transport Channel
SUPL Secure User Plane Location
TB Terrestrial Beacon
TBS Terrestrial Beacon System
TCI Transmission Configuration Indicator
TECU TEC Units
TLM Telemetry
TOA Time Of Arrival
TOF Time of Flight
TP Transmission Point
TRP Transmission-Reception Point
UE User Equipment
UDRE User Differential Range Error
ULP User Plane Location Protocol
URA User Range Accuracy
UTC Coordinated Universal Time
WGS 84 World Geodetic System 1984
WLAN Wireless Local Area Network

1. A network node for wireless communication comprising:
at least one memory; and
at least one processor coupled with the at least one memory and configured to cause the network node to:
send a positioning training dataset configuration that comprises a request for a positioning training dataset for training a machine learning positioning model, and a required data format of the positioning training dataset based on a location of the network node; and
receive a response comprising the positioning training dataset according to the required data format.

2. The network node of claim 1, wherein the at least one processor is further configured to cause the network node to receive the response from at least one of:
a serving gNodeB or a neighboring gNodeB;
a serving transmit receive point or a neighboring transmit receive point;
a positioning reference unit user equipment;
a positioning reference unit transmit receive point;
a reference user equipment;
a target user equipment;
an assistance user equipment;
a third party user equipment;
a network data analytic function; or
a location management function.

3. The network node of claim 1, wherein the network node is at least one of:
a location server node;
a next generation radio access network node;
a positioning reference unit gNodeB;
a positioning reference unit transmit receive point;
a positioning reference unit user equipment;
a reference user equipment;
an assistance user equipment;
a third party user equipment; or
a target user equipment.

4. The network node of claim 3, wherein the next generation radio access network node comprises a serving gNodeB or a neighboring gNodeB, or a serving transmit receive point or a neighboring transmit receive point.

5. The network node of claim 1, wherein the positioning training dataset configuration comprises a reporting configuration that is at least one of instantaneous, periodic, or event-based.

6. The network node of claim 1, wherein the machine learning positioning model comprises a machine learning direct positioning model or a machine learning assisted positioning model.

7. The network node of claim 1, wherein the required data format is structured according to a type of the machine learning positioning model.

8. The network node of claim 1, wherein the required data format comprises at least one of a positioning measurement, a configurable location information of a location at which the positioning measurement is performed, a time information of the positioning measurement, or a quality of the positioning measurement.

9. The network node of claim 8, wherein the configurable location information comprises at least one of:
a 2D or 3D coordinate;
a zone identifier;
a grid identifier;
a speed or velocity;
an orientation;
a heading;
a height; or
a rectangular grid having a length and a width.

10. The network node of claim 1, wherein the at least one processor is further configured to cause the network node to receive an activation request for activating the network node to at least one of send the positioning training dataset configuration, receive the positioning training dataset, or train the machine learning positioning model.

11. The network node of claim 1, wherein the at least one processor is further configured to cause the network node to receive a deactivation request for the network node to at least one of not send the positioning training dataset configuration, not receive the positioning training dataset, or not train the machine learning positioning model.

12. (canceled)

13. The network node of claim 1, wherein the at least one processor is further configured to train the machine learning positioning model using a positioning training dataset received from a local data source.

14. The network node of claim 1, wherein the positioning training dataset configuration further comprises an indication as to whether the positioning training dataset is intended for online and/or offline training of the machine learning positioning model.

15. A method performed by a network node, the method comprising:
sending a positioning training dataset configuration comprising a request for a positioning training dataset for training a machine learning positioning model, and a required data format of the positioning training dataset based on a location of the network node;
receiving a response comprising the positioning training dataset according to the required data format; and
training the machine learning positioning model using the positioning training dataset.

16-28. (canceled)

29. A network node for wireless communication, comprising:
at least one memory; and
at least one processor coupled with the at least one memory and configured to cause the network node to:
receive a positioning training dataset configuration that comprises a request for a positioning training dataset for training a machine learning positioning model, and a required data format of the positioning training dataset based on a location of the network node; and
transmit a response comprising the positioning training dataset according to the required data format.

30. The network node of claim 29, wherein the at least one processor is further configured to cause the network node to receive the response from at least one of:
a serving gNodeB or a neighboring gNodeB;
a serving transmit receive point or a neighboring transmit receive point;
a positioning reference unit user equipment;
a positioning reference unit transmit receive point;
a reference user equipment;
a target user equipment;
an assistance user equipment;
a third party user equipment;
a network data analytic function; or
a location management function.

31. The network node of claim 29, wherein the required data format comprises at least one of a positioning measurement, a configurable location information of a location at which the positioning measurement is performed, a time information of the positioning measurement, or a quality of the positioning measurement.

32. A method performed by a network node, the method comprising:
transmitting a positioning training dataset configuration comprising a request for a positioning training dataset for training a machine learning positioning model, and a required data format of the positioning training dataset based on a location of the network node; and
transmitting a response comprising the positioning training dataset according to the required data format.

33. The network node of claim 1, wherein the at least one processor is further configured to cause the network node to train the machine learning positioning model using the positioning training dataset.

34. The network node of claim 33, wherein the at least one processor is further configured to cause the network node to transmit an output of the trained machine learning positioning model to another network node.
